(19) United States
(12) Patent Application Publication
(10) Pub. No.: US 2010/0009622 A1
(43) Pub. Date: Jan. 14, 2010

(54) Electronic Content Ordering Method and System

(76) Inventor: Li Chen, Dallas, TX (US)

Correspondence Address: SLATER & MATSIL, L.L.P., 17950 PRESTON RD, SUITE 1000, DALLAS, TX, 75252-5793, US

(21) Appl. No.: 12/446,906

(22) PCT Filed: Nov. 2, 2007
(86) PCT No.: PCT/US2007/083424

§ 371 Date: Apr. 23, 2009

Related U.S. Application Data
(60) Provisional application No. 60/856,234, filed on Nov. 2, 2006.

(51) Int. Cl. H04H 20/71; H04M 1/00

(52) U.S. Cl. 455/3.01; 455/550.1

(57) ABSTRACT

A system and method for ordering broadcast content using associated metadata. Metadata, which has been added to the broadcast transmission or otherwise transmitted is separated and transmitted to a personal communication device, preferably from the broadcast transmission receiver over a short-range radio frequency channel. The PCD uses the metadata to order the content from a content provider over a communications network and, if necessary, execute payment. The contact is then downloaded for storage and later use.

This application claims the benefit of U.S. Provisional Application No. 60/856,234, filed on Nov. 2, 2006, entitled “Electronic Content Ordering Method and System,” which application is hereby incorporated herein by reference.

### TECHNICAL FIELD

The present invention is directed generally to the field of electronic content procurement, and more specifically directed to a system and method for facilitating the convenient ordering of content via an electronic communications network.

### BACKGROUND

Electronic signals have long been used to transmit information. From the original telegraph, telephone, and radio transmissions, rapid advances in technology have led to modern communications networks that can transmit sounds, pictures, and data. For example, broadcast radio transmits electronic media in the form of radio waves at pre-selected frequencies such that properly tuned receivers are able to receive and convert back into the transmitted sounds. Voice and music content, for example are transmitted in this manner. As is well-known, much of the content currently being broadcast in this way is not created at the time of transmission, that is, is not “live,” but rather has been previously-recorded for future play or transmission.

Another example involves the broadcast of audio-video information over selected frequencies so that appropriately tuned receivers—for example, television sets—can receive the broadcast signals in order to process it and play the transmitted video images and associated sound, if any. Again, some of the content being broadcast is live, and some has been pre-recorded.

Broadcast media is generally transmitted for the use of media consumers equipped with an appropriate receiver, such as a radio or television. A great deal of broadcast media is free to anyone with a receiver, although some broadcast media is available only to subscribers, who often possess special equipment that is made available only to subscribers. In some instances broadcasts are sent only for a specific purpose, such as with training or motivational presentations transmitted by large companies or organizations. Although broadcast in the sense that they are sent to a large (and perhaps variable) number of recipients, the intended audience is relatively small compared to that of commercial or public broadcast stations.

Whatever type of broadcast is taking place; the content of the broadcast is the main message that which is to be presented in audio or video format, or both, to a large audience. The content is the reason the broadcast is being sent, and the reason the listeners or viewers “tune in” their receivers to receive it. Other types of information may, however, be sent as well. In particular, a certain type of information called “metadata” includes additional information that relates to the content. This metadata, often much more limited in quantity than the content itself, may nevertheless prove useful. For example, a piece of music broadcast to radio listeners may sometimes be identifiable to those that recognize the music or the performers, or both. For others, or even at times for audiophiles, the title and artist may not be discernable. Metadata sent along with the content, however, may carry this information in such a way that it may be made accessible to the user.

A representation of the metadata may, for example, be displayed on a display screen associated with the radio, such as the one depicted in FIG. 1. FIG. 1 is a simplified illustration of the front of an exemplary broadcast radio receiver 10. The front 12 of the radio 10 may be the only side actually visible, or even assessable to the user, that is, the person listening to the broadcast, especially if the radio is mounted in an automobile. Radio 10 includes a tuning knob 15 that may be manipulated by the user to adjust which broadcast station the radio is tuned to, that is, to choose which broadcast will be selected for listening. Other devices, such as a slide, rocker switch, or button, may be used in place of the knob 15 to similar effect a speaker (not shown) is disposed behind speaker openings 20, and includes the components necessary to create and amplify sounds corresponding to the broadcast content. The speaker or speakers need not lie behind the front 12 of the radio 10, however, and are often separate components connected to radio 10 by a wire or wireless connection.

The front 12 of radio 10 includes a first display 17 for indicating which station the radio 10 is tuned to. Older radios used a needle or pointer movable along a fixed scale for this purpose, though more contemporary radios are likely to have an electronic display, such as an LED (light-emitting diode) array or an LCD (liquid crystal display). Electronic displays have the advantage of being programmable to display a variety of information and can be changed quickly. The first display 17 of FIG. 1 shows “98.5” and “FM”, which in this case corresponds to a radio station broadcasting at a radio frequency of 98.5 mega Hertz (MHz), is in the so-called FM band (portion) of the radio-frequency spectrum. This displayed information is presented to the user as a representation of the frequency; of course, the actual tuning mechanism is within the radio itself and not shown in FIG. 1.

Activating one of the pre-set buttons 21 through 26 may also change the frequency being received. For the user's convenience, these buttons may be set to tune the receiver to a specific frequency when depressed, without having to pass through intermediate frequencies. Radio 10 is also equipped with a volume adjustment knob 30 and two rocker switches 32 and 34 that may be manipulated to adjust the relative output of each of four external speakers from front (F) to back (B) and from right (R) to left (L). The status of each of these adjustment levels (not shown) may also be displayed on first display 17. Note that the adjustment knobs and switches shown in FIG. 1 are exemplary and may vary considerably from receiver to receiver.

Radio 10 also includes a second display 40 capable of alphanumeric information. In this radio 10, the information displayed here is a representation of the metadata that is being received at radio 10 from a radio broadcast station along with the content to which the listener may be listening. The metadata therefore contains indications of whatever information that will be displayed. In FIG. 1, this information indicates that the current program content is Symphony No. 5 by Beethoven. It could also indicate the particular performance being broadcast is by the London Philharmonic Orchestra, though often such information is scrolled through because currently most radio receiver displays are too limited in capacity to display all of the available information at once. Other information may, of course be available for display as well, and in some instances the user may be able to control which, if any, information is displayed.

As mentioned above, the metadata is typically transmitted from a broadcast station along with the content itself. This is graphically represented in FIG. 2. FIG. 2 is a simplified block diagram representing selection components of radio broadcast system 50. Broadcast station 52 includes a powerful transmitter 55 that receives input from either a live source 53 of a recorded source 54 (or both) and amplifies it for transmission through broadcast antenna 60. In FIG. 2, the transmission of both content 61 and metadata 62 are represented separately for illustration, although in reality they are often combined into a single broadcast signal.

Both content 61 and metadata 62 are transmitted across the public airwaves at a pre-determined frequency, reaching, for example, an automobile 70. Automobile 70, in this example, includes a radio (not shown in FIG. 2) capable of receiving the broadcast content 61 and presenting it in audio form for a listener in automobile 70. The radio in automobile 70 may also be able to extract the metadata 62 and present it in some form to the listener (see, for example, second display 40 shown in FIG. 1). Note that in many cases, the metadata information 62 may be inserted into or combined with the content 61 in such a way that the receiver may extract or separate it, without making a perceptible difference in the presentation of the content at the radio. As should be apparent, the manner for extracting the metadata is ideally somewhat standardized so that each broadcast station may insert the metadata confident that many or most commercially available broadcast receivers (of the appropriate type) will be capable of extracting it. Generally, broadcast receivers that are not capable of metadata extraction may simply ignore it without affecting the presentation of the content to the user.

When metadata is inserted into a radio (or other) broadcast, it is typically synchronized with the content in such a way such that a display representing the metadata presents information relevant to the content being presented. For example, when broadcasting metadata that will cause an appropriately configured receiver to display “Symphony No. 5”, this display should be presented at the same time, or nearly the same time as the piece is being presented (played) by the receiver. For broadcast content, of course, this is at very nearly the same time that it is broadcast. In some applications, the metadata transmission may have to begin at a time slightly different from the associated content to ensure that it is displayed contemporaneous with the music playing.

Consumers, of course, often purchase media in prerecorded form as well. There are several ways to do this. Audio content may be purchased on magnetic tapes or CDs (compact discs), for example, and audio-video content may be purchased on videocassette tapes or DVDs (digital versatile disks). In addition, content may be purchased through an electronic network and stored on media already owned by the consumer. Cable networks and the Internet are examples of such electronic communications networks.

To purchase content from a cable network, for example, a consumer may contact this provider and agree to pay a fee to have the service provided to them. The cable service provider then supplies the equipment necessary to decode a signal transmitted over a cable, for example a coax cable, running to the subscribers home or office from the provider's office, usually through a number of switches or hubs. Where it does not exist already, the cable may have to be installed between the subscriber's location and the nearest hub or switch. Once the equipment is installed, the subscriber may usually receive and play content as provided by the cable provider. In some instances the subscriber, for example, may order additional content for an extra fee. In such cases, the signal from the provider may not change, but the ability to decode certain portions of it may be adjusted.

Purchasing electronic content over the Internet typically involves a similar, though not identical, process. To access content via the Internet a consumer will ordinarily purchase a personal computer or similar device. Some means is then found to connect the Internet, using the personal computer. Note that the Internet is a worldwide network of interconnected computer networks to which connection is frequently made through an Internet service provider (ISP). Consumers frequently connect through an ISP, though larger entities, such as content vendors, may be directly connected and, in that sense, serve as their own ISP.

To purchase electronic content over the Internet, a number of vehicles are available. By far the most common is to access using the World Wide Web (WWW) to retrieve content stored at various Web sites. Having “located” such a site, the consumer follows the instructions “posted” there to find out what content is available for purchase and under what conditions it may be obtained. Once these parameters have been determined, the content is chosen by the consumer and “downloaded,” that is, transferred from the provider to the consumer via the Internet and their respective connections to it.

Once the content has been purchased, it may be played by a listener on an appropriate device, sometimes the same one that is used for receiving broadcast content. The front 12 of radio 10 of FIG. 1, for example, forms an opening 45 into which a CD containing prerecorded content may be inserted. Naturally, the internal equipment necessary for playing CDs must be present (but is not shown in FIG. 1). Operation of the CD player is, in this example, controlled by manipulating one or more of control buttons 46 positioned on the front 12 of radio 10. The recorded content is presented to the user in similar fashion as that being broadcast. In some instances, metadata will be included with recorded content as well, and in that case may be extracted in similar fashion as with broadcast content.

Interestingly, however, there is currently no convenient way to purchase for later use content that is being broadcast. That is, broadcast content is (nearly) instantaneously available at the receiver, but is presented only at the moment of its broadcasting. In some cases, the broadcast content may be recorded using the listener's reception equipment if it is so capable. This procedure, however, is less than optimal because the quality of the received signal may result in an unsatisfactory recording. The broadcast signal is simply not intended for this purpose; interruptions and commentary, especially at the beginning and end of a musical selection, are common. Moreover, the necessary recording equipment is often unavailable at the time of the broadcast, and if the cost of installing it, for example in automobile 70, is not justifiable for only occasional use.

Heretofore, the only alternative has been to wait and purchase the same or similar content in the conventional manner. It would be therefore advantageous to consumers if broadcast electrical content could be ordered near the time of broadcast and obtained in a quality form. The present invention provides just such a solution.

### SUMMARY OF THE INVENTION

These and other problems are generally solved or circumvented, and technical advantages are generally achieved, by preferred embodiments of the present invention, which facilitate the convenient and efficient distribution of content to consumers.

In accordance with a preferred embodiment of the present invention, a method for distributing content comprises associating the content with metadata that identifies the content sufficiently for procurement by a person receiving the broadcast, broadcasting the content and the associated metadata, receiving a request for downloading a copy of the content, the request containing information extracted from the metadata, and downloading the requested content according to the terms of the request. The method may also include negotiating arrangements for payment in consideration of downloading the content. In one embodiment, the content is downloaded over a telecommunication network by the broadcast station that broadcast the content and the metadata. In another embodiment, the content downloader is a separate entity, and may or may not be communicating with the broadcast station.

In accordance with another preferred embodiment of the present invention, a system for procuring broadcast content, comprising a broadcast receiver for receiving a broadcast including both content and metadata associated with the content, the broadcast receiver having a metadata extractor for extracting the metadata from the broadcast and operable to transmit the metadata to a personal communication device (PCD), and a PCD operable within a telecommunication network, wherein the PCD is operable to receive metadata extracted by the broadcast receiver and use the information contained therein to generate a download request for transmitting to a download content provider over the telecommunication network. The PCD is also preferably operable to receive and store the content when downloading occurs.

An advantage of a preferred embodiment of the present invention is that it permits recipients of program content that is associated with metadata to quickly and efficiently order a downloaded copy of the content using their PCD.

A further advantage of a preferred embodiment of the present invention is that it may provide consumers receiving broadcast content associated with metadata to have a greater opportunity for selecting a content provider of their choice. On the other hand, a preferred embodiment of the present invention may also provide an opportunity for vendors of content, especially those associated with broadcast entities to increase content sales by making the purchasing process easier and available almost immediately to the consumer.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a simplified illustration of the front of an exemplary broadcast radio receiver;

FIG. 2 is a simplified block diagram representing selection components of radio broadcast system;

FIG. 3 is an illustration of a PCD (personal communication device) according to an embodiment of the present invention;

FIG. 4 is a simplified schematic diagram illustrating selected internal components of a PCD according to one embodiment of the present invention;

FIG. 5 is a simplified schematic drawing illustrating selected components of broadcast receiver according to one embodiment of the present invention;

FIG. 6 is a simplified block diagram illustrating a network according to an embodiment of the present invention;

FIG. 7 is a flow diagram illustrating a method of distributing content according to one embodiment of the present invention;

FIG. 8 is a flow diagram illustrating a method of obtaining content according to another embodiment of the present invention; and

FIG. 9 is a simplified schematic drawing illustrating selected components of a content-ordering adaptor according to one embodiment of the present invention.

### DETAILED DESCRIPTION OF ILLUSTRATIVE EMBODIMENTS

The present invention provides a system and method for conveniently ordering broadcast content, such as music or video content broadcast from a radio or TV station, without the need to acquire physical media embodying the content. That is the content is downloaded (transmitted electronically from a source to a specific consumer) through a telecommunication network.

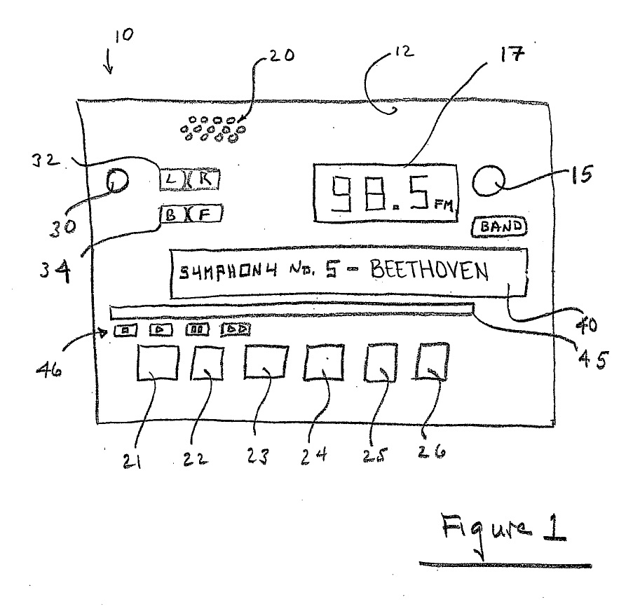

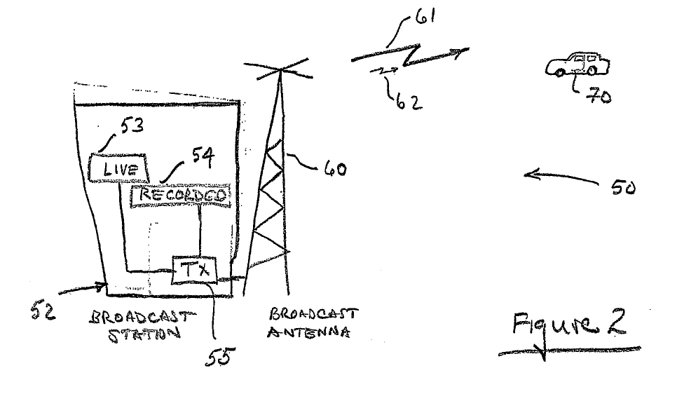

The present invention, then, is directed to a system and method for vending content through an electronic communication network. This content may include various kinds of audio, video, and “multi-media” presentations that may be stored and transmitted in electronic form. The present invention may, for example be advantageously applied by a radio listener, for example, a person listener listening to radio 10 shown in FIG. 1. As mentioned above, modern-day radio broadcasts are more and more frequently accompanied by metadata, that is, information about the content being transmitted. This metadata may, for example, permit a radio receiver to display the name of the song or other program material, the call letters of the radio station, or other information that the viewer may be interested in seeing or that the broadcaster may be interested in sending.

A listener driving in an automobile, however, is only able to listen to the broadcast program at the time it is being sent, absent some recording capability rarely present vehicular radios. Even where the radio may have a recording function, many listeners are respectful of the copyrights of others and will therefore not use a recorder to make unauthorized copies of the songs or other materials being presented. And often such recordings are of a less than desirable quality. If they wish, of course, the listeners may simply purchase a CD or audiotape having the same music, and play it on a suitable media player. They may also later visit a Web site set up for the purpose of selling song recordings legally, assuming they have the equipment necessary to do so.

The rapid advance of modern technology, however, has given rise to high expectations for convenience and speed among consumers, and they may be unwilling to wait until they have the opportunity to purchase the program content in one of the forms described above. They may want to acquire a recording as soon as they hear the content, and may also realize that perhaps later they will have forgotten the artist and title, or not even remember to make the purchase at a time when facilities are available for doing so. Vendors, of course, may be expected to want to vend their product immediately for the same or similar reasons, that is, because the buying impulse may fade, or the potential sale lost or delayed because it does not soon enough become convenient to make a purchase that is currently being contemplated.

It is in these or similar scenarios that the system and method of the present invention may be most advantageously applied. In the situation described above, it enables a listener driving a car to rapidly and conveniently purchase a song heard playing on the radio. An embodiment of the invention applied to such a use will now be described in more detail. As will be apparent, similar advantages will present themselves in other situations where broadcast content is being received.

In this embodiment, the content ordering takes place using a PCD. Once rarely seen in private use, these small communication stations are now widely available and commonly used. Although not required unless specifically recited, PCDs are typically portable, batter-powered radio-frequency communications devices that may transmit and receive on one or more channels according to one or more communication protocols. Mobile telephones, sometimes popularly referred to as cell phones, are one example. As used herein, however, PCD will include mobile phones, cell phones, satellite phones, and similar devices, such as PDAs (personal digital assistants) with transmit and receive communication capabilities. Typically such devices are used for voice communications, but are increasingly being used for text messaging and, where capable, email and the downloading of Web pages. As their name implies, PCDs are most often used by a single user at one time, or at most a very small group of users. The fact that they are usually portable means that in practice; they may be carried about by the person that they belong to.

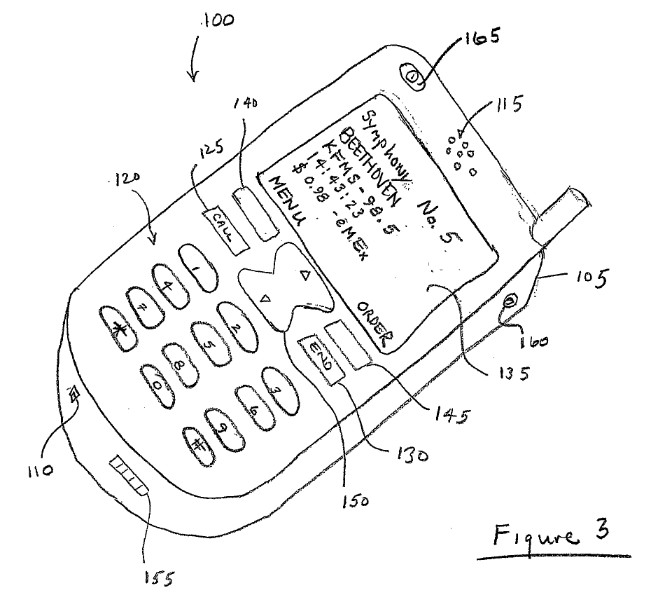

FIG. 3 is an illustration of a PCD 100 according to an embodiment of the present invention. PCD 100 typically includes a microphone (not shown) located inside housing 105 near microphone opening 110. A speaker (also not shown) is likewise situated near speaker openings 115. The microphone and speaker are, of course, used for voice communications, and may perform other functions as well. Housing 105 also forms an opening 160 for receiving a power plug, which plugs into a jack (not shown) positioned just inside opening 160. As mentioned above, however, PCD 100 is typically powered from an internal battery, and the connection to an external power source is only necessary to recharge the battery, to conserve battery power, or in the event of a battery malfunction. Power key 165 is used to turn the device on and off, and sometimes to place it in or out of a standby mode. An external device port 155 allows external devices of many different kinds to be connected to PCD 100 using a wired, rather than wireless, interface.

Keypad 120 is used for the input of numeric or alphanumeric information. “Call” key 125 and “end” key 130 are used respectively for initiating and terminating calls. A display 135 is used for visually presenting information such as telephone numbers and device status. Function keys 140 and 145 work in conjunction with the display 135, typically being configured to perform whatever function is currently displayed next to them. The word “MENU” near function key 140, for example, indicates that activating key 140 will call a pre-programmed menu function through which a number of operations can be performed. These operations may include accessing a list of stored phone numbers or changing the manner in which the terminal alarms to notify the user that an incoming call is attempting to connect. Scroll key 150 may also be used in connection with items appearing on display 135, for example to scroll through a sequence of menus to be displayed serially or through a series of items currently shown on display 135.

In the embodiment FIG. 3, the word “ORDER” appears on display 135 near function key 145, which indicates that activating key 145 will call a pre-programmed order function according to an embodiment of the present invention. To order specific content, the user simply depresses key 145. In this example, the selection being ordered is Beethoven's Symphony No. 5, as indicated by the text presented on the display 135. Also shown in this example are the broadcast radio station's call letters and broadcast frequency. All of the information presented on the display 135, in other words, is typically present in the metadata that is frequently sent along with the content of a radio broadcast.

In the embodiment of FIG. 3, the price to be charged for ordering this selection is also displayed, along with the abbreviation eMEx, standing for electronic Music Exchange, a hypothetical vendor from whom the selection, once ordered, will be downloaded. This is because the actual music vendor and the broadcast radio station are different entities in this embodiment, as may frequently be but is not necessarily the case.

Whether a third party vendor is used or not, it may still be of some advantage to also include the vendor identity and price in the metadata that is sent with the content. This allows for some flexibility in pricing—with some radio broadcasters negotiating better sale prices than others. Note, however, that there is no requirement that any fee at all be charged for downloading the content, whether from the radio station or from a third party. In yet another embodiment, the listener may be provided with a number of procurement options. Although each of these examples implies that each musical selection is purchased one at a time, on an individual basis. This, however, is not a requirement. The user may maintain a subscription, for example, that permits a certain number of music-selection downloads. Or a number of selections could be bundled together for ordering, and perhaps downloading, during a single session, perhaps to receive a discounted price.

In an embodiment where the vendor or price is not provided in the metadata, the listener's PCD may simply receive instructions to contact the broadcast radio station or some other party to obtain this information. In other words, this information in the metadata simply needs to provide a sufficient starting point for the ordering process. In fact, in one embodiment, only the identity of the broadcast radio station and a time stamp—from which the desired musical selection (or other content) may be determined. Note that in this case ordering multiple selections at once may still be possible, provided that sufficient information has been stored.

The PCD, in a preferred embodiment, receives the metadata information directly from the radio 10 (or other content receiver), which extracts the metadata from the broadcast signal and retransmits it. In some applications, this retransmission may be continuous, regardless of whether a PCD is within range. In other embodiments, the metadata (whether extracted for other reasons or not) is only retransmitted based on a request received from the PCD. As should be apparent, “retransmitted” is used here for convenience because in this embodiment, metadata that was transmitted from the broadcast station has been received and the broadcast station has been received at the broadcast receiver, and then is retransmitted from the broadcast receiver to the PCD. The retransmitted metadata need not be, however, identical to the metadata transmitted from the broadcast station. It may be reformatted, for example, or items of information added or removed.

In another embodiment, the PCD does not receive retransmitted metadata directly from the broadcast content receiver at all. Instead, the PCD is configured to receive broadcasts directly, and extracts the metadata on its own. To do this, of course, the PCD must be aware of this identity of the broadcaster from which the current radio content is being received. (Alternatively the PCD may in rare cases extract metadata being transmitted by a different broadcaster than the one transmitting the content then being played).

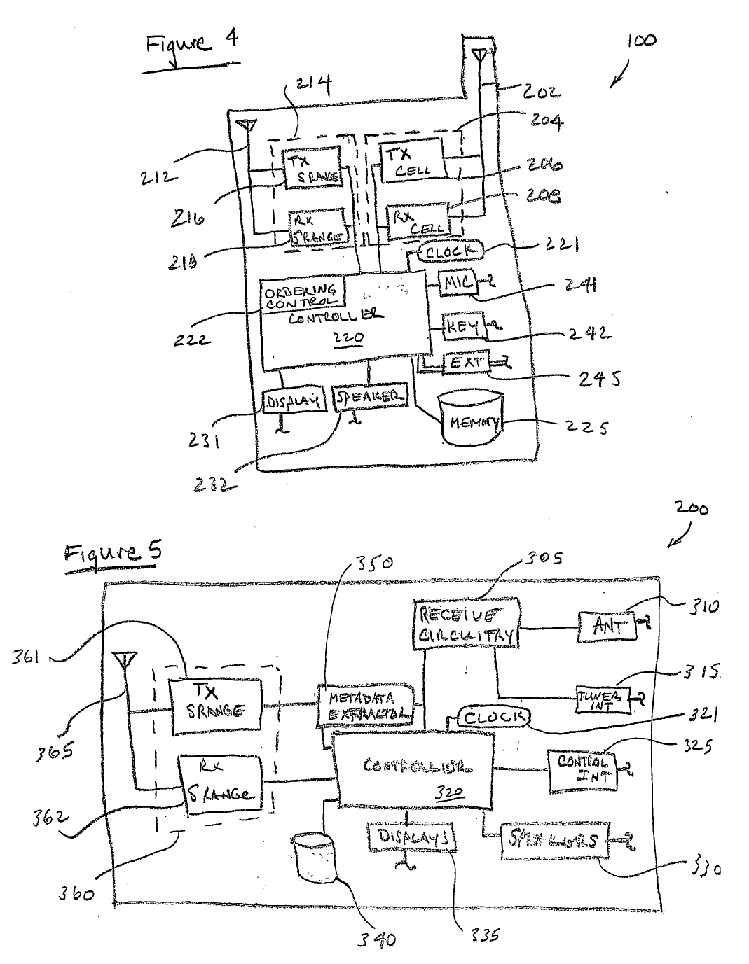

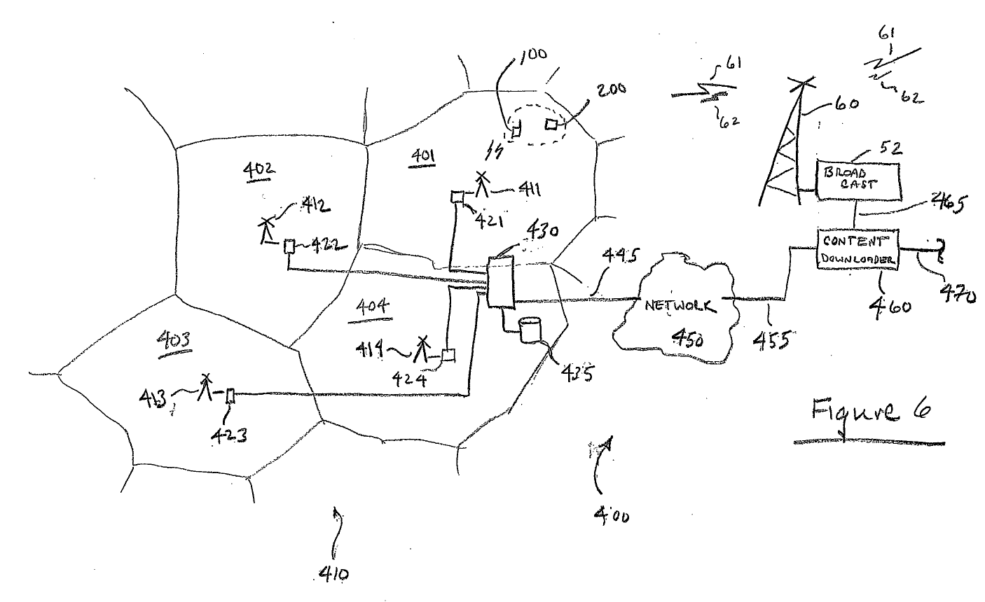

In a preferred embodiment, however, metadata that is associated with content transmitted from a broadcast station is received at a broadcast transmission receiver, separated from the content, and retransmitted for reception by a PCD. The PCD then executes an ordering process and, in most embodiments, eventually receives the downloaded content. For this to occur, of course, both devices must be operable according to the present invention. FIGS. 4 and 5 will be used to illustrate this point.

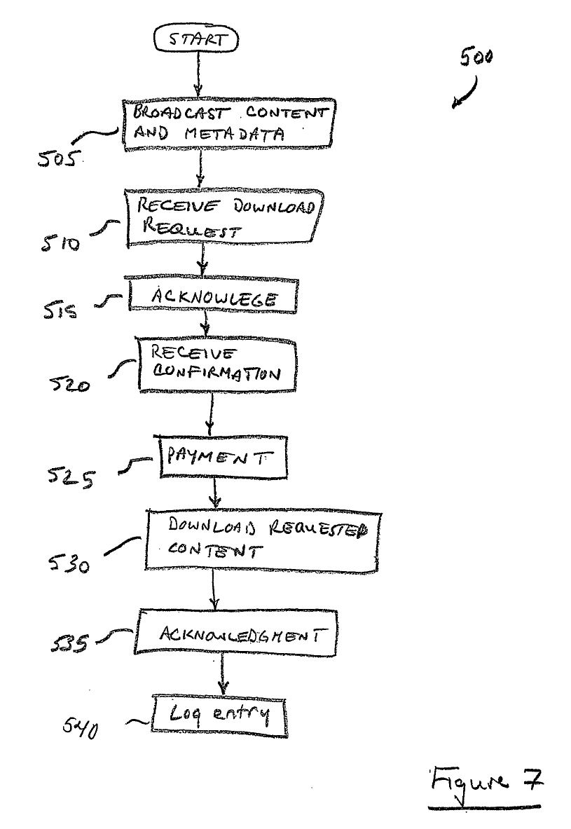

FIG. 4 is a simplified schematic diagram illustrating selected internal components of PCD 100 according to one embodiment of the present invention. In this embodiment, PCD 100 is equipped with both short range and long-range communication capability. To this end, a first antenna 202 is coupled to a first transceiver 204, which includes first transmit circuitry 206 and a first receive circuitry 208 for communicating over a telecommunication network such as a cellular telephone network (see, for example, FIG. 6). PCD 100 in this embodiment uses transceiver 204 for voice and data communications and to order and download musical selections through a network according to the present invention. Also present in PCD 100 is a short-range radio transceiver 214, which includes short range transmit circuitry 216 and short range receive circuitry 218, each coupled to short-range antenna 212. Short-range transceiver 214 is used to communicate with other, analogously equipped devices in the area according to a short-range radio protocol such as Bluetooth or IEEE 802.11b. In accordance with an embodiment of the present invention, this short range electromagnetic or radio frequency (RF) communication capability is used, among other things, to communicate with a broadcast radio receiver to receive broadcast metadata information related to broadcast content that a listener may wish to order. A clock 221 is present so that a certain time may be associated with the receipt of certain metadata, or of downloaded content.

Note that instead of two (or more), there may instead be only a single transceiver or a single antenna performing both short-range functions. Note also that the short-range radio connection and the cellular network connection are exemplary; other types of networks or communications protocols may be used as well. In some applications, both functions may in fact be handled over a single communications medium, though this is not presently preferred. Returning to the embodiment of FIG. 4, each of these transceivers 204 and 214 operate under the direction of a controller 220, which controls the other components of PCD 100 as well. This includes a display interface 231 and a speaker interface 232 for presenting information to the user. It also includes various user-input interfaces such as, in this embodiment, microphone interface 241 and keypad interface 242. An external device interface 245 may be used when the PCD 100 is connected to an external device at external device port 155 (shown in FIG. 3). Controller 220 is coupled to a memory device 225, which in this embodiment not only stores programs and data in connection with the typical telephone operations of PCD 100, but is also used for storing downloaded content ordered according to the present invention. The stored content may then be presented (played) on the PCD 100 itself, or transferred to another device for this purpose. In this embodiment, for example, such a transfer could be accomplished through short-range transceiver 214, cellular transceiver 204, or external device interface 245.

In accordance with this embodiment of the present invention, controller 220 includes an ordering control module 222. Ordering control module 222, which may alternately be a separate device within PCD 100, collects the metadata extracted from a broadcast transmission and determines from it how to contact an entity for obtaining a downloaded copy of the content associated with the metadata. Once this determination is made, ordering control module 222 oversees the ordering process, including, as necessary, obtaining any other necessary information, confirming the order with the user, actually placing the order, and facilitating the actual download. It may also handle any necessary payment arrangements and order confirmation. Ordering control module 222 may also perform an error checking function to help ensure the quality of the downloaded content.

FIG. 5 is a simplified schematic drawing illustrating selected components of broadcast receiver 200 according to one embodiment of the present invention. In this embodiment, broadcast receiver 200 includes receive circuitry 305 coupled to an antenna interface 310 for connecting to an external antenna (not shown). The receive circuitry 305 is also coupled to a tuner interface 315 connected, for example, to a tuning knob or pre-set buttons (see FIG. 1), so that the listener may change the station being listened to. The broadcast radio input is provided to a controller 320, which in turn provides a signal to the speaker interface 330, which in this simplified example includes whatever amplifiers are necessary before driving one or more external speakers (not shown) to produce the sound the listener hears. Input related to volume, balance, and other audio characteristics is provided to the controller 320 through control interface 325.

In the embodiment of FIG. 5, also included in broadcast receiver 200 is a metadata extractor 350. Metadata extractor 350 operates under the control of controller 320 and is coupled to receiver 305 so that it may detect and extract the metadata, if any, present in a received broadcast signal. Note that in this embodiment, metadata extractor 350 is depicted as a separate component, but in alternate embodiments it may simply be a function of the controller itself. In yet another embodiment, it may be instead (or also) present in PCD 100 (shown in FIG. 4), which may then receive the entire broadcast signal either from the broadcast receiver 200 or in some applications directly from the broadcast station. Returning to the embodiment of FIG. 5, the extracted metadata may then be used to create a presentation, for example the name of a musical selection, to be sent to a display (see, for example, FIG. 1) through display interface 335.

In accordance with this embodiment of the present invention, the extracted metadata is transmitted by short range transceiver 360, which includes a short range transmitter 361 and short range receiver 362 both coupled to an antenna 365 (here a separate, internal antenna, but others may also be used, including external antenna accessed via antenna interface 310). As should be apparent, the short-range transceiver 360 may be used to communicate with a personal communication device such as PCD 100 to send metadata in support of the ordering function. The receiver 362 is not always used, for example where the metadata is simply retransmitted as soon as it is extracted. The receiver 362 may be used, however, for receiving metadata requests or other messages from PCDs (or other devices) in the vicinity. The short-range transceiver 360 need not be used exclusively for executing the methods of the present invention; of course, it may have other uses as well, for example communicating with a remote control device. The metadata extracted by metadata extractor 350 may also be stored in memory device 340 for future reference or transmission. Requests or other messages from a PCD or other device may be stored there as well. In some embodiments, metadata or other stored information may be time stamped with the time determined by clock 321.

In the event that broadcast receiver and PCD are not fully capable of communicating with each other to carry out any or all steps of the invention (or, in some instances, even if they are so equipped), a content-ordering adaptor may be used. FIG. 9 is a simplified schematic drawing illustrating selected components of a content-ordering adaptor 900 according to one embodiment of the present invention. In this embodiment of FIG. 9, content-ordering adaptor 900 includes, not unexpectedly, a broadcast receiver interface 910 and a PCD interface 990 for connecting respectively to the broadcast receiver and to the PCD. These interfaces may include a wire and jack for making the connection, or use a wireless connection such as radio frequency or optical. A preferred adaptor will include several interfaces so that it may be used in a variety of different environments. Of course, the interface channels used at any one time do not have to be the same, although they could be. In an alternate embodiment (not shown), a single interface may be shared for connecting the other devices.

In the embodiment of FIG. 9, adaptor 900 also includes receive circuitry 915 that may, through antenna 920, receive broadcast signals (or other communications). Where this is present, no connection to the broadcast receiver may be necessary. The adaptor 900 also includes a metadata extractor 925 for extracting the metadata from a broadcast program received through receive circuitry 915 (or received through the broadcast receiver interface 910). A clock 945 is available for time stamping extracted (or received) metadata (and other functions as well), and a memory device 940 may be used for storing this information.

In this embodiment all of these modules operate under the control of controller 930, although in some cases the adaptor 900 is controlled by the controller 220 of the PCD (shown in FIG. 4), or controller 320 of the broadcast receiver 200 (shown in FIG. 5). In other embodiments, control may actually be shared.

Returning to the embodiment of FIG. 9, a reformatter 935 is coupled to controller 930 for reformatting the metadata for passing it to the PCD via PCD interface 990. Shown as a separate component here, reformatter 935 may also simply be a function incorporated into controller 930. Finally, control interface 950 and display interface 955 are used in conjunction with whatever user-interface devices (not shown) are present in adaptor 900.

As should be apparent, content-ordering adaptor according to the present need not contain all, or be limited to the internal component modules shown here. And the presence (or absence) of a component in the adaptor does not require or imply the absence (or presence) of an analogous component in the broadcast receiver or PCD.

FIG. 6 is a simplified block diagram illustrating a network 400 according to an embodiment of the present invention. PCD 100 is, in essence, a medium-range radio station. To successfully communicate over large distances, a network is required. One such network is often referred to as a cellular network. The network 400 includes a cellular network 410, so-called because the coverage area (only a portion of which is shown in FIG. 6) is divided in to cells, or geographic areas anywhere from approximately 0.5 to 12 miles across. Each cell is served by at least one antenna, through which each mobile terminal in the cell may communicate with a base station.

For example, illustrated in FIG. 6 are cells 401 through 404, each including respectively, antennae 411 through 414. Each of these antennae is, in turn, connected to a respective base station 421 through 424. Mobile station 100 is, for example, capable of communicating with base station 421 through antennae 411 because it is located physically in cell 401. In practice, however, cell phones such as cell phone 100 are operable to communicate through the antennae of neighboring cells as well. In a typical network, protocols are in place to permit mobile stations to be handed off from base station to base station as they travel, and excess traffic in one cell may be handled by the base station of an adjacent cell.

A mobile station may travel from cell to cell, for example, because the user (consumer) is in transit in an automobile. In such a situation, as is common, the consumer may also be listening to the radio. This is of course possible because the automobile is likely equipped with a receiver capable of receiving broadcast (or multicast) radio transmissions from a broadcasting station.

In cellular network 410, each of the depicted base stations 421 through 424 is connected to a central station 430, probably through a cable or fiber optic connection. Central station 430 may handle calls between parties in any one of cells 401 through 404, but more significantly in connection by line 445 to a network 450 so that calls to distant parties and other networks are possible. In FIG. 6, network 450 generally represents one of a number of possible networks including the remainder of the cellular network, other such networks, the Internet, or a wire line telephone network.

In FIG. 6, also connected to network 450 by line 455 is content downloader 460. Content downloader 460 is, in this embodiment, a separate component connected by line 465 to broadcast station 52. Line 470 indicated a possible separate connection to another network, another broadcast station, or a payment system. In another embodiment, however, any or all of these functions may simply be incorporated into broadcast station 52.

In another embodiment (not shown), a content downloader is associated with the cellular network 410, and itself received the broadcast containing the metadata. Upon extracting the metadata, a provider other then the broadcast station is found for the content being broadcast. When a listener requests the content in this scenario, the request goes directly to the cellular network operator (not shown), which then in turn downloads the content via the cellular network or in some other manner. The network operator may then collect from the consumer a fee for downloading the content, a portion of which will be paid to the ultimate content provider. The advantage for the network operator is that they could offer another fee service to consumers already being billed for cellular phone service. No separate payment arrangement would be needed.

As mentioned above, broadcast station transmits both content 61 and metadata 62 to (typically) a relatively large area. The broadcast content is received by receive circuitry in receiver 200, which may, for example, be an automobile radio. PCD 100 is, in this embodiment, assumed to be co-located with broadcast receiver 200. When broadcast receiver 200 receives the broadcast, it retransmits the metadata to PCD 100, either continuously or upon request.

When a listener of broadcast receiver 200, for example, hears a musical selection they would like to order, they are then able to do so quickly and conveniently, using a PCD such as PCD 100, which obtains the necessary metadata and places the order. This process will now be examined in more detail.

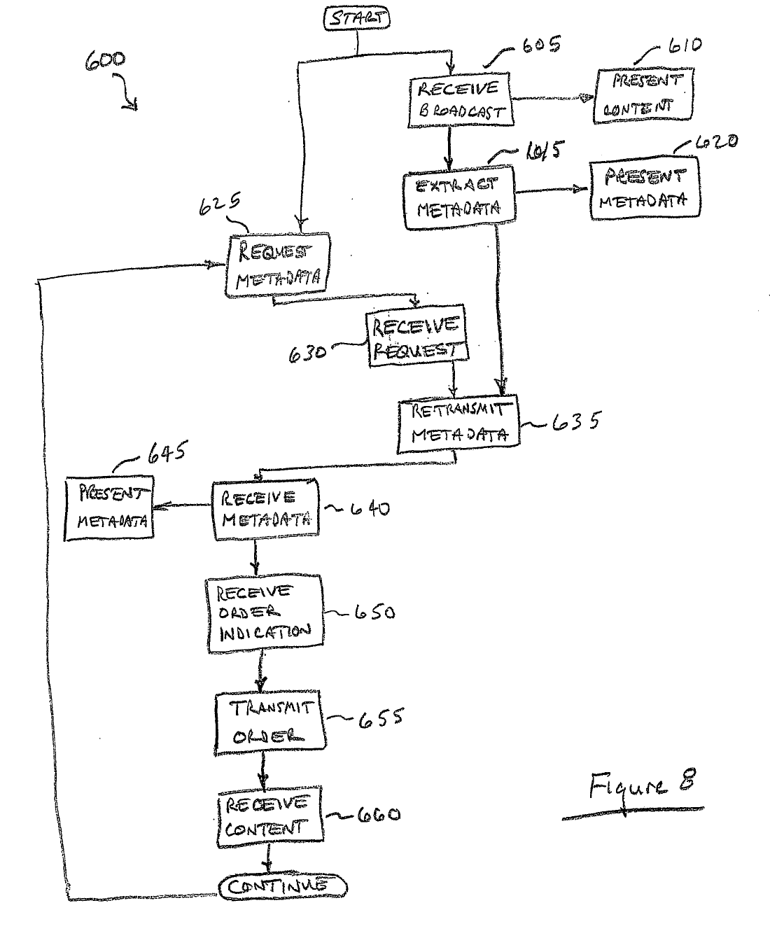

FIG. 7 is a flow diagram illustrating a method 500 of distributing content according to one embodiment of the present invention. At START it is assumed that the networks and network nodes (described above) necessary to implement the present invention have been provided. The method then begins with the electronic broadcasting of content, accompanied by metadata identifying the content, from a broadcast node of the network (step 505). As used herein, broadcasting implies transmission of the content to a wide audience for immediate consumption, that is listening or viewing or both. This definition is meant to include, for purposes of describing the invention, multicasting and transmission to a subscriber base such as those found in connection with satellite radio or television or cable TV operations. Broadcasting also includes, of course, programs that are transmitted over the airwaves for reception by any viewer with a receiver and without the need to subscribe to the broadcaster's network.

The method of this embodiment continues with the reception at a control node, for example content downloader 460 (shown in FIG. 6), of a content request that has been generated by a personal communication device (PCD) such as a mobile phone (step 510). The content request includes content identification information extracted from the metadata and the identity of the requesting entity. When the content request is received, an acknowledgement message is transmitted (step 515) from the control node to the PCD, typically but not necessarily over the same telecommunication network that carried the request. As mentioned above, the broadcast node and the control node may be housed together in the same station or even in the same device, or may be separately located.

In this embodiment, the method continues with the reception at the control node of a confirmation message (step 520) from the PCD over the telecommunication network. Note that neither the acknowledgement nor the confirmation message is necessary, but each is preferably used to insure that the inadvertent or undesirable ordering of content is avoided. Other means of providing similar protections are possible, such as maintaining a database of phone numbers from which orders will, or alternately, will not be accepted.

In a preferred embodiment, however, the acknowledgement and confirmation are also used to verify the download parameters, such as the communications channel over which the downloading is to occur, and the address of the intended recipient. While it may be presumed in the first instance that the content should be downloaded to the same device as the order was received from, and over the same network, this is not necessarily the case. The content could, for example, be sent to an e-mail account.

In the embodiment of FIG. 7, once a confirmation message is received, payment is negotiated, executed, and confirmed (collectively, step 525). There are a number of ways in which this may be accomplished. In the case of a content broadcast over a subscriber network, the means for setting a price and executing payment are probably established. In other situations, payment by credit card, debit card, or via a third-party payment system may be used. In some instances an account will simply be created that the intended recipient will presumably settle at some later time. Note, however, that notwithstanding the use of the terms “vend” and “payment” there is no requirement that the content requester is charged any type of fee, or that the payment is actually collected. In some instances, the content may be provided gratuitously, for example to members of an exclusive or non-exclusive class as a promotion. In this case the payment step may be eliminated, or alternately simplified to a determination that the potential recipient is entitled to the content requested.

Once payment, if necessary, has been confirmed, the content is downloaded (step 530) to the recipient at the presumed or agreed upon address. In a preferred embodiment, receipt of the content is then acknowledged (step 535). If no acknowledgement is received, or alternately when a negative (failure) acknowledgement is received, the content transmission is attempted again (step not shown). In the embodiment of FIG. 7, a log entry is then made (step 540) in a database associated with the control node, preferably recording the content sent, the time and date of the transmission, and the identity of the recipient.

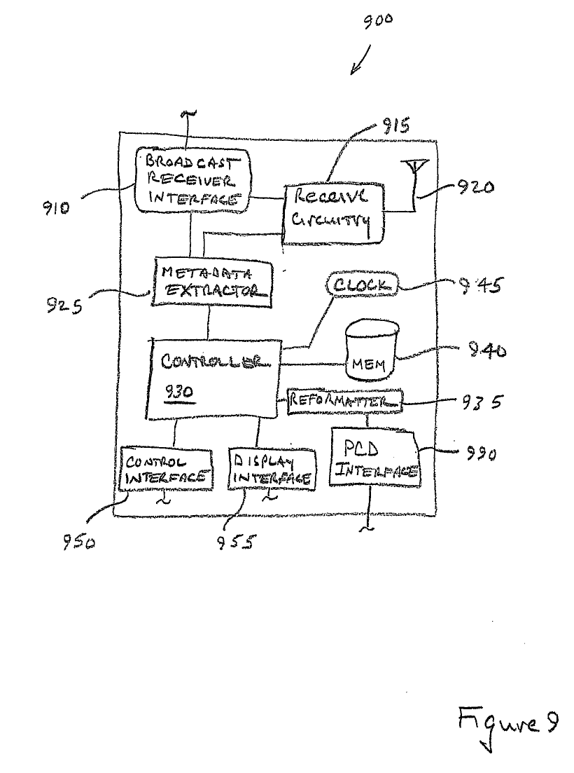

In accordance with another embodiment, the present invention is a method of obtaining content. FIG. 8 is a flow diagram illustrating a method 600 of obtaining content according to another embodiment of the present invention. Again, at START, it is presumed that the hardware and software necessary for executing the method 600 is available and operational. The method according to this embodiment begins with the reception of a broadcast program (step 605) containing both content and metadata, for example at an automobile radio. The broadcast receiver also may be a PCD, either the content ordering PCD or a separate PCD. The program content in this case may be a song or other musical selection, or an interview or the play-by-play description of a sporting event. The metadata includes information identifying or describing the content it is associated with (which is normally the content being broadcast at the same time or nearly the same time.

The broadcast receiver uses the metadata and the content in different ways. The content is presented (step 610), in this embodiment this means processed and amplified for play on speakers that are in or connected to the radio. The metadata is extracted (step 615), that is, separated from the main broadcast signal as necessary for separate use (no specific signal-processing procedure is implied). In this embodiment, a representation of the metadata is displayed on a display screen of the radio (step 620). As mentioned above, the present invention provides a considerable advantage to a listener in a traveling auto, who may easily order a particular song upon hearing it (or even, if the radio has for some reason been muted, upon seeing a metadata display related to it). Although playing the content and displaying the metadata are both typical and desirable, however, they are not a required part of practicing the method of the present invention unless specifically claimed. Note that some or all of the extracted metadata may at this point be time-stamped and stored for later reference (steps not shown). A means for reviewing the stored metadata may also be provided to some advantage.

In any event, in accordance with this embodiment of the present invention, the method continues with the transmission of a request for metadata information from a PCD to the broadcast receiver (step 625), the PCD likely being accessible to a listener listening to the radio. Preferably, the PCD is operable to communicate with the broadcast receiver using short-range radio frequency transmissions according to, for example, a Bluetooth or an 802.11 protocol. The connection may also be made by wire or optical (such as infra red) connection, and may include an adaptor performing any steps not executable by the broadcast receiver or PCD. In any case, when the broadcast receiver receives the request (step 630), it retransmits (step 635) all or some of the metadata associated with broadcast content to the PCD. In some applications, the metadata may be first converted into a more suitable format before re-transmission. Note that in an alternate embodiment, the metadata re-transmission is sent continuously, perhaps in short bursts. Where transmission of the metadata is continuous, the PCD may, and preferably will not store all of the metadata transmissions. The unneeded data is simply ignored, or it may be stored for a short term (for example, a few minutes, or one hour, depending on the capacity of the PCD memory) and then discarded if unused.

In another alternative, the metadata transmission begins upon the occurrence of a triggering event. Such a triggering event may include detecting the within-range presence of a PCD with compatible communication capabilities. Such devices are known to periodically search for other compatible devices. In another embodiment, the metadata may be continuously provided to the content ordering device without a specific request being sent. In yet another embodiment, the listener may activate a PCD function to manually prompt the broadcast receiver to begin metadata retransmissions, or similarly adjust the function of the broadcast receiver itself. Indeed, the system could be configured so that the process could be initiated at either device. This may be useful, for example, where the PCD, which is perhaps a cellular telephone, might already be in use when a listener wishes to commence ordering. Wherever the process is not begun immediately, of course, the metadata received at the PCD may simply be stored for later use. It is preferred that the PCD is configured to allow for delayed ordering simply because it may be used for other functions, and because access to telecommunication networks is often more limited than access to broadcast transmissions, meaning that ordering immediately may not be possible at all.

Returning to the embodiment of FIG. 8, the PCD receiving the metadata then continues with the ordering process, preferably when activated by the user to do so. In other words, the PCD could simply order the content associated with the metadata whenever the necessary metadata has been received; this, however, is not preferred. In the preferred embodiment, when the PCD receives the metadata (step 640), a representation of the metadata is presented on the PCD display screen (step 645). The process continues when an order indication is received in the PCD (step 650), presumably initiated by some action of the listener (such as activating the ORDER key—see FIG. 3).

When the order indication is received, the PCD transmits an order message (step 655), for example over a telecommunication network to a content downloader. In this embodiment, payment terms are then negotiated and payment authorized (though the payment itself, if any, may be made immediately or at a later time). The desired content is then received (step 660), either at the PCD over the telecommunication network or by some alternate downloading path, such as a pre-established e-mail account. The listener then has a personal copy of the content for playback as desired, delivered within relatively short time after it is broadcast (and perhaps before it is done playing on the radio). The process of method 600 then continues when initiated by the listener, for example by initiating another request for metadata at step 625.

In an alternate embodiment (not shown), the listener may be given an opportunity to confirm that the metadata received at the PCD is correct. Where this option is not available, the content associated with the metadata displayed at step 640 is either ordered or not ordered by the listener. In some instances, however, the metadata received at the PCD will not correspond to the listener's wishes, either it was not requested at the right time, for example, or it was improperly synchronized with the wrong content. Whatever the reason, the listener may want to attempt correcting the situation. In this instance, the listener may be permitted, perhaps using the keys of the PCD, to scroll back and forward through other metadata that has been received and, presumably in this case, stored. This procedure may also be used simply to provide the opportunity to reconsider content not previously chosen. When the correct metadata is presented to the user, the ordering process may continue as described above at step 645.

In some other applications, the listener may also be given the opportunity to select a particular vendor, either from an offered list or simply another of the listener's choosing (and for which the listener will supply a phone number or other contact information). The listener may also choose to delay the decision to order, or the placing of the order itself. In some embodiments, the listener may also specify an address (other that the PCD from which the order is being placed) to which the content is to be downloaded. (Note that although the term “listener” is used for illustration, there is no requirement that anyone has heard the selection, or even that it has been played).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A device for ordering content received by a broadcast receiver using metadata associated with the content, the device comprising:
a personal communication device (PCD) operable to communicate over a communication network, wherein the PCD is operable to communicate with the broadcast receiver so that metadata received by the broadcast receiver also is received by the PCD, and wherein the PCD is operable to order the content associated with the received metadata by communicating with either a content provider or a third party provider via the communication network.

2. The system of claim 1, wherein the PCD is a mobile telephone.

3. The system of claim 1, wherein the PCD is the broadcast receiver.

4. The system of claim 1, wherein the broadcast receiver is a radio operable to receive commercial radio broadcasts.

5. The system of claim 4, wherein the content provider is a commercial broadcast radio station.

6. The system of claim 1, further comprising a content-ordering adaptor that enables the PCD to communicate with the broadcast receiver.

7. The system of claim 6, wherein the content-ordering adaptor comprises a memory for storing extracted metadata.

8. The system of claim 7, wherein the content-ordering adaptor further comprises a clock, and wherein the adaptor memory stores clock data associated with the extracted metadata.

9. The system of claim 7, wherein the PCD comprises a display operable to display a representation of the extracted metadata.

10. The system of claim 1, wherein the PCD receives and stores the requests.

11. A method for ordering content, the method comprising:
receiving a broadcast comprising program content and metadata identifying the content;
extracting the metadata;
providing at least a portion of the extracted metadata to a PCD; and
transmitting from the PCD a request for the content identified in the metadata.

12. The method of claim 11, further comprising receiving the content requested by the PCD.

13. The method of claim 12, wherein the PCD is a cellular telephone and the request for the content is transmitted via a cellular telecommunication network.

14. The method of claim 13, wherein the requested content is received via downloading via the cellular telecommunication network.

15. A method for distributing content, the method comprising:
broadcasting from a broadcast station a signal comprising content and metadata associated with the content;
receiving a request to download the content, the request including metadata information extracted from the broadcast metadata; and
downloading the content.

16. The method of claim 15, further comprising arranging for payment for the requested download.

17. The method of claim 15, wherein the request to download is received at the broadcast station.

18. The method of claim 15, wherein the request to download is received at a content provider in communication with the broadcast station.
